(19) United States
(12) Patent Application Publication
(10) Pub. No.: US 2012/0200731 A1
(43) Pub. Date: Aug. 9, 2012

(54) COLOR RESTORATION APPARATUS AND METHOD

(75) Inventors: Byung-Kwan Park, Seoul (KR); Joo-Young Kang, Yongin-si (KR); Seong-Deok Lee, Seongnam-si (KR); Won-Hee Choe, Yongin-si (KR)

(73) Assignee: SAMSUNG ELECTRONICS CO., LTD., Suwon-si (KR)

(21) Appl. No.: 13/167,818

(22) Filed: Jun. 24, 2011

(30) Foreign Application Priority Data
Feb. 7, 2011 (KR) 10-2011-0010747

(51) Int. Cl. H04N 9/73

(52) U.S. Cl. 348/223.1

(57) ABSTRACT

A color restoration apparatus is provided. The color restoration apparatus including a color correction gain generator configured to compensate for a first broad-band pixel value of a first image, which is acquired from a single-exposure environment, based on a saturation gain for compensating for a difference between a time of the saturation of a broad-band pixel value and a time of the saturation of a narrow-band pixel value, and to calculate a color correction gain based on a first narrow-band pixel value of the first image and the compensated first broad-band pixel value, and a color corrector configured to compensate for a second broad-band pixel value of a second image, which is acquired from a dual-exposure environment, based on a color gain difference compensation value for compensating for a difference between color gains applied to the second image, and to calculate a restored narrow-band pixel value based on the second narrow-band pixel value, the compensated second broad-band pixel value, and the color correction gain.

### CROSS-REFERENCE TO RELATED APPLICATION(S)

This application claims the benefit under 35 U.S.C. §119(a) of Korean Patent Application No. 10-2011-0010747, filed on Feb. 7, 2011, in the Korean Intellectual Property Office, the entire disclosure of which is incorporated herein by reference for all purposes.

### BACKGROUND

1. Field

The following description relates to a color restoration apparatus and method.

2. Description of the Related Art

Typical image acquisition apparatuses may often fail to provide clear and vivid images in certain environments such as a low-light environment. A low-light environment is a challenging environment for typical image acquisition apparatuses, and it is difficult to provide high-quality images simply by using image sensors that only utilize short-wavelength light such as red, green, blue, cyan, magenta, or yellow light. In order to acquire high-quality images in, for example, a low-light environment, the use of image sensors that can absorb long-wavelength light as well as short-wavelength light may be required.

Broad-band filters may be used for absorbing long-wavelength light. However, the use of broad-band filters for absorbing long-wavelength light may cause crosstalk between pixels. The crosstalk may thus result in color distortions in pixels corresponding to narrow-band filters near the broad-band filters. Thus, a demand for research into ways to reduce such color distortions has increased.

### SUMMARY

In one general aspect, a color restoration apparatus is provided. The color restoration apparatus includes a color correction gain generator configured to compensate for a first broad-band pixel value of a first image, which is acquired from a single-exposure environment, based on a saturation gain for compensating for a difference between a time of the saturation of a broad-band pixel value and a time of the saturation of a narrow-band pixel value, and to calculate a color correction gain based on a first narrow-band pixel value of the first image and the compensated first broad-band pixel value, and a color corrector configured to compensate for a second broad-band pixel value of a second image, which is acquired from a dual-exposure environment, based on a color gain difference compensation value for compensating for a difference between color gains applied to the second image, and to calculate a restored narrow-band pixel value based on the second narrow-band pixel value, the compensated second broad-band pixel value, and the color correction gain.

The color correction gain generator may include a first calculator configured to calculate the saturation gain based on the first narrow-band pixel value and the first broad-band pixel value.

The first calculator may be further configured to, in a case in which there are a plurality of first narrow-band pixel values, compute a ratio of the first broad-band pixel value to the sum of the first narrow-band pixel values as the saturation gain.

The color correction gain generator may include a saturation compensator configured to compensate for the first broad-band pixel value based on the saturation gain.

The saturation compensator may be further configured to compensate for the first broad-band pixel value based on the saturation gain in response to the first broad-band pixel value being saturated.

The color correction gain generator may include a second calculator configured to calculate the color correction gain based on the first narrow-band pixel value and the compensated first broad-band pixel value.

The color corrector may include an exposure compensator configured to compensate for the second narrow-band pixel value based on a first color gain and compensate for the second broad-band pixel value based on a second color gain to compensate for exposure.

The color corrector may further include a third calculator configured to calculate an exposure gain based on the first and second color gains.

The third calculator may be further configured to compute a ratio of the first and second color gains as the exposure gain.

The color corrector may further include an extractor configured to extract a color gain difference compensation value corresponding to the exposure gain.

The color corrector may include a color gain difference compensator configured to compensate for the second broad-band pixel value based on the color gain difference compensation value.

The color corrector may include a fourth calculator configured to calculate the restored narrow-band pixel value based on the second narrow-band pixel value, the compensated second broad-band pixel value, and the color correction gain.

The first and second images may be substantially the same.

In another general aspect, a color restoration method is provided. The color restoration method includes compensating for a first broad-band pixel value of a first image, which is acquired from a single-exposure environment, based on a saturation gain for compensating for a difference between a time of the saturation of a broad-band pixel value and a time of the saturation of a narrow-band pixel value, calculating a color correction gain based on a first narrow-band pixel value of the first image and the compensated first broad-band pixel value, compensating for a second broad-band pixel value of a second image, which is acquired from a dual-exposure environment, based on a color gain difference compensation value for compensating for a difference between color gains applied to the second image, and calculating a restored narrow-band pixel value based on the second narrow-band pixel value, the compensated second broad-band pixel value, and the color correction gain.

The color restoration method may further include calculating the saturation gain based on the first narrow-band pixel value and the first broad-band pixel value.

The calculating the saturation gain may include, in a case in which there are a plurality of first narrow-band pixel values, computing a ratio of the first broad-band pixel value to the sum of the first narrow-band pixel values as the saturation gain.

The compensating for the first broad-band pixel value may include compensating for the first broad-band pixel value based on the saturation gain in response to the first broad-band pixel value being saturated.

The color restoration method may further include compensating for the second narrow-band pixel value based on a first color gain and compensating for the second broad-band pixel value based on a second color gain to compensate for exposure.

The color restoration method may further include calculating an exposure gain based on the first and second color gains.

The calculating the exposure gain may include computing a ratio of the first and second color gains as the exposure gain.

The color restoration method may further include extracting a color gain difference compensation value corresponding to the exposure gain.

The first and second images are substantially the same.

In yet another general aspect, a color restoration method is provided. The color restoration method includes acquiring a first image from a single-exposure environment, calculating a saturation gain based on a first narrow and broad-band pixel values of the first image, in response to the first broad-band pixel value being saturated, compensating the first broad-band pixel value based on the calculated saturation gain, calculating a color correction gain based on the first narrow-band pixel value and the compensated first broad-band pixel value, acquiring a second image from a dual-exposure environment, compensating for a second narrow-band pixel values of the second image and a second broad-band pixel values of the second image based on a first and second color gains, respectively, calculating an exposure gain based on the first and second color gains, compensating the second broad-band pixel values based on the calculating exposure gain, and calculating a restored narrow-band pixel value based on the second narrow-band pixel value, the second broad-band pixel value and the color correction gain.

The compensating of the second broad-band pixel values may comprises extracting a color gain difference compensation value corresponding to the calculated exposure gain to be used in the compensating.

The first and second images may be substantially the same.

An image acquisition apparatus including a housing, and a color restoration apparatus. The color restoration apparatus including a color correction gain generator configured to compensate for a first broad-band pixel value of a first image, which is acquired from a single-exposure environment, based on a saturation gain for compensating for a difference between a time of the saturation of a broad-band pixel value and a time of the saturation of a narrow-band pixel value, and to calculate a color correction gain based on a first narrow-band pixel value of the first image and the compensated first broad-band pixel value, and a color corrector configured to compensate for a second broad-band pixel value of a second image, which is acquired from a dual-exposure environment, based on a color gain difference compensation value for compensating for a difference between color gains applied to the second image, and to calculate a restored narrow-band pixel value based on the second narrow-band pixel value, the compensated second broad-band pixel value, and the color correction gain.

Other features and aspects may be apparent from the following detailed description, the drawings, and the claims.

### BRIEF DESCRIPTION OF THE DRAWINGS

FIG. 1 is a diagram illustrating an example embodiment of a color restoration apparatus.

FIG. 2 is a diagram illustrating an example embodiment of a color filter array.

FIGS. 3A and 3B are diagrams illustrating an example embodiment of a table listing various color gain difference compensation values for various exposure gains.

FIGS. 4A and 4B are flowcharts illustrating an example embodiment of a color restoration method.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

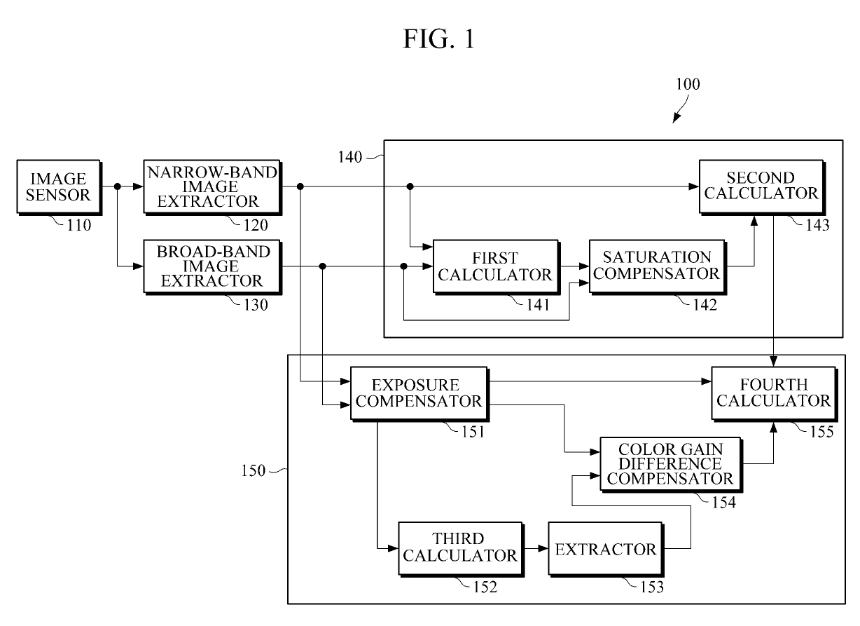

FIG. 1 illustrates an example embodiment of a color restoration apparatus. Referring to FIG. 1, a color restoration apparatus 100 includes an image sensor 110, a narrow-band image extractor 120, a broad-band image extractor 130, a color correction gain generator 140, and a color corrector 150.

The image sensor 110 may generate an image by sensing light transmitted to the image sensor 110 through a lens (not shown) and a color filter array (not shown). For example, the color filter array may include a plurality of narrow-band filters and a plurality of broad-band filters. The narrow-band filters may be filters that only transmit therethrough light that have a wavelength that falls within a narrow wavelength range, such as red, green, blue, cyan, yellow, magenta, and black filter. The broad-band filters may be filters that transmit therethrough light ranging over a wide wavelength range, such as panchromatic filters, or white & near infrared (WNIR) filters. Panchromatic filters may also be referred to as white filters. The wide wavelength range may include not only wavelength ranges corresponding to red, green, and blue but also a near infrared (NIR) wavelength range. Panchromatic filters may transmit therethrough light having a wavelength that falls within the wavelength ranges corresponding to red, green, and blue, and WNIR filters may transmit therethrough both light having a wavelength that falls within the wavelength ranges corresponding to red, green, and blue and light having a wavelength that falls within the NIR wavelength range.

Pixel values may be digital values representing the amount of light detected. For example, when pixel values are 8-bit digital values, the amount of light detected may be represented by a number that falls within the range of 0 to 255. A darkest color may be represented by a pixel value of 0, and a brightest color may be represented by a pixel value of 255. Pixel values may have various sizes in bits, such as, for example, a 12- or 16-bit size.

An image generated based on light transmitted through broad-band filters may hereinafter be referred to as a broad-band image, and an image generated based on light transmitted through narrow-band filters may hereinafter be referred to as a narrow-band image. Pixel values of a broad-band image may hereinafter be referred to as broad-band pixel values, and pixel values of a narrow-band image may hereinafter be referred to as narrow-band pixel values.

The narrow-band image extractor 120 may extract a narrow-band image from one or more images generated by the image sensor 110.

The broad-band image extractor 130 may extract a broad-band image from one or more images generated by the image sensor 110.

The term ‘single-exposure environment’, as used herein, may indicate an environment in which broad- and narrow-band pixel values are obtained under the same conditions. In a single-exposure environment, no additional processes for compensating for narrow- and broad-band pixel values may be necessary. The term ‘dual-exposure environment,’ as used herein, may indicate an environment in which broad- and narrow-band pixel values are obtained under different conditions. In a dual-exposure environment, unlike in a single-exposure environment, additional processes for compensating for exposure-induced differences between broad- and narrow-band pixel values may be necessary. The additional processes for compensating for exposure-induced differences between broad- and narrow-band pixel values may be performed by the exposure compensator 151, which will be described later in further detail.

The color correction gain generator 140 may include a first calculator 141, a saturation compensator 142, and a second calculator 143.

The color correction gain generator 140 may generate a color correction gain based on a first image obtained from a single-exposure environment. The first image may include first broad- and narrow-band images. The first broad-band image may include at least one first broad-band pixel value, and the first narrow-band image may include at least one first narrow-band pixel value.

The first calculator 141 may calculate a saturation gain based on the first narrow- and broad-band pixel values. The saturation gain may be a gain used to compensate for the difference between a time of a saturation of the first broad-band pixel value and a time of a saturation of the first narrow-band pixel value. For example, when there are a plurality of first narrow-band pixel values, the ratio of the first broad-band pixel value to a sum of the first narrow-band pixel values may be computed as the saturation gain.

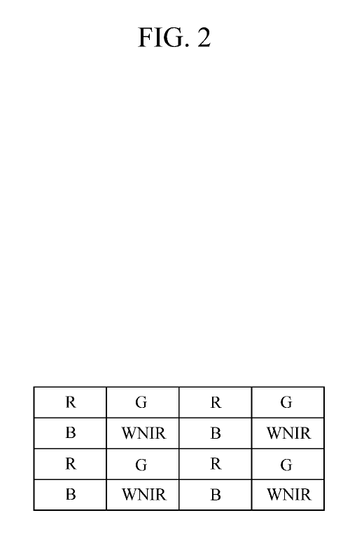

FIG. 2 illustrates an example of a color filter array.

Referring to FIG. 2, the first calculator 141 may calculate a saturation gain based on a first narrow-band pixel value and a first broad-band pixel value. For example, when there are a plurality of narrow-band color channels (for example, red, green, and blue channels) and there are a plurality of narrow-band pixel values R, G, and B, the first calculator 141 may compute the ratio of the broad-band pixel value WNIR to the sum of the narrow-band pixel values R, G, and B as a saturation gain c by using the following equation: c=WNIR/(R+G+B). When the broad-band pixel value WNIR is 250 and the sum of the narrow-band pixel values R, G, and B is 200, the saturation gain c is 1.25. The above equation is exemplary, and the first calculator 141 may use various methods, other than the equation set forth herein, to compute the saturation gain c. For example, to compute the saturation gain, a weight may be applied to the narrow-band pixel values R, G, and B or an average of the narrow-band pixel values R, G, and B may be used. The saturation gain c may vary according to color temperature.

In response to the first broad-band pixel value being saturated, the saturation compensator 142 may compensate for the first broad-band pixel value based on the saturation gain c. When the first narrow-band pixel value and the first broad-band pixel value are both 8-bit pixel values that fall within the range from 0 to 255, the saturation compensator 142 may determine that the first broad-band pixel value is saturated in response to the first broad-band pixel value reaching 255. Since the first broad-band pixel is different from the first narrow-band pixel in terms of the range of wavelengths absorbed, the first broad-band pixel value may be saturated ahead of the first narrow-band pixel value. The first broad-band pixel value may be different from the first narrow-band pixel value in terms of when to be saturated.

For example, when the broad-band pixel value WNIR reaches a highest value of 255 and the sum of the narrow-band pixel values R, G, and B is 200, the saturation compensator 142 determines that the broad-band pixel value WNIR is saturated. In this case, even if the sum of the narrow-band pixel values R, G, and B gradually increases to 240, the broad-band pixel value WNIR may be uniformly maintained at 255. In order to compensate for the difference between the time of the saturation of the broad-band pixel value and the time of the saturation of the sum of the narrow-band pixel values R, G, and B, the saturation compensator 142 may compensate for the broad-band pixel value WNIR based on the saturation gain c. For example, the saturation compensator 142 may obtain a compensated broad-band pixel value of 360 by compensating for the pixel value WNIR, as indicated by the following equation: WNIR=(R +G+B)*c=240*1.5=360. The saturation compensator 142 may compensate for broad-band pixel values by taking into consideration that broad-band pixel values are saturated ahead of narrow-band pixel values.

The second calculator 143 may calculate a color correction gain based on the first narrow-band pixel value and the compensated first broad-band pixel value provided by the saturation compensator 142. For example, the color correction gain may be represented as a matrix such as, for example, a 3*4 matrix. The second calculator 143 may calculate the color correction gain using various color correction gain calculation algorithms.

The color corrector 150 includes an exposure compensator 151, a third calculator 152, an extractor 153, a color gain difference compensator 154, and a fourth calculator 155. The color corrector 150 may perform color correction using a second image, which is obtained from a dual-exposure environment and may include second broad- and narrow-band images. The second broad-band image may include a second broad-band pixel value, and the second narrow-band image may include a second narrow-band pixel value.

The exposure compensator 151 may compensate for the second broad- and narrow-band pixel values by using different color gains in order to apply different exposure levels to narrow- and broad-band pixel values in a dual-exposure environment. For example, the exposure compensator 151 may compensate for the second narrow-band pixel value using a first color gain, and may compensate for the second broad-band pixel value using a second color gain. The exposure compensator 151 may compensate for exposure by applying different color gains to narrow- and broad-band pixel values.

The third calculator 152 may calculate an exposure gain based on the first and second color gains used by the exposure compensator 151. The exposure gain may be a gain for compensating pixel values to accommodate for an exposure environment from which the pixel values originate from. For example, the exposure gain may be the ratio of the first and second color gains. However, the exposure gain of the present invention is not restricted to the ratio.

The extractor 153 may extract a color gain difference compensation value corresponding to the exposure gain. The color gain difference compensation value may be a value used to compensate for the difference between the first and second color gains used by the exposure compensator 151. The exposure gain and the color gain difference compensation value may be stored in a table in association with each other.

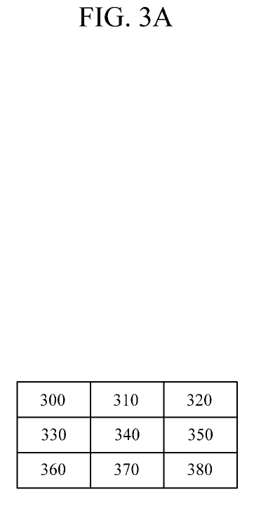

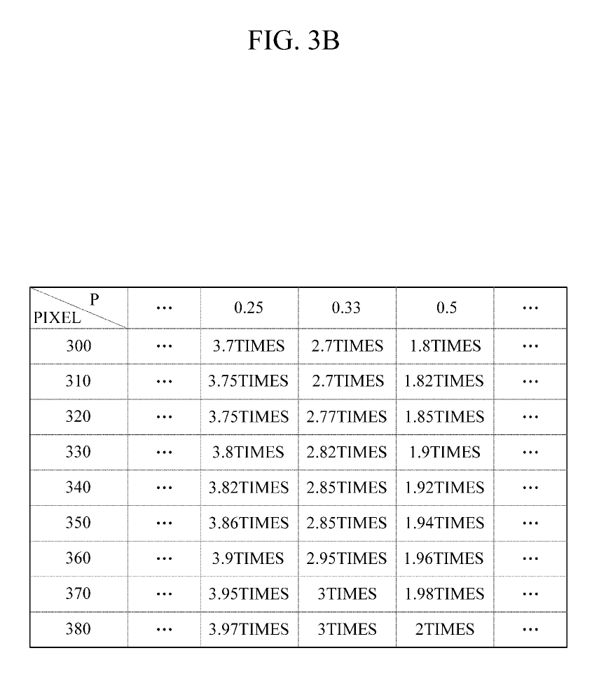

FIGS. 3A and 3B illustrate an example embodiment of a table listing various color gain difference compensation values for various exposure gains.

Referring to FIGS. 3A and 3B, assume that there are nine pixels (for example, first, second, third, fourth, fifth, sixth, seventh, eighth, and ninth pixels 300, 310, 320, 330, 340, 350, 360, 370, and 380). However, the present invention is not restricted to the nine pixels. The table shown in FIG. 3B lists the first, second, third, fourth, fifth, sixth, seventh, eighth, and ninth pixels 300, 310, 320, 330, 340, 350, 360, 370, and 380 and color gain difference compensation values for different exposure gains P for each of the first, second, third, fourth, fifth, sixth, seventh, eighth, and ninth pixels 300, 310, 320, 330, 340, 350, 360, 370, and 380. For example, a color gain difference compensation value may be computed as the amount (e.g., 150) or the factor (e.g., 3.2 times) to compensate a pixel value. The color gain difference compensation values listed in the table shown in FIG. 3B may be computed as the factors to compensate pixel values.

For example, when the exposure gain P is 0.25, the extractor 153 may extract a color gain difference compensation value of 3.7 times for the first pixel 300 and may extract a color gain difference compensation value of 3.75 times for the second pixel 310. The extractor 153 may extract the color gain difference compensation values for the third, fourth, fifth, sixth, seventh, eighth, and ninth pixels 320, 330, 340, 350, 360, 370, and 380 for the exposure gain of 0.25. The extraction may use the same method used to extract the color gain difference compensation values for the first and second pixels 300 and 310 when the exposure gain is 0.25.

The color gain difference compensator 154 may compensate for the second broad-band pixel value based on the color gain difference compensation value extracted by the extractor 153. For example, if the first pixel 300 is the second broad-band pixel, the first pixel 300 has a value of 50, the exposure gain P is 0.25, and a color gain difference compensation value for the first pixel 300 for the exposure gain of 0.25 is 3.7 times, the color gain difference compensator 154 may compensate for the value of the first pixel 300 from 50 to 185 (=50*3.7). As another example, if the ninth pixel 380 is the second broad-band pixel, the ninth pixel 380 has a value of 40, the exposure gain P is 0.25, and a color gain difference compensation value for the ninth pixel 380 for the exposure gain of 0.25 is 3.97 times, the color gain difference compensator 154 may compensate for the value of the ninth pixel 380 from 40 to 158.8 (=40*3.97). The color gain difference compensator 154 may compensate for the second broad-band pixel value and may represent the compensated second broad-band pixel value as an integer value. For example, the color gain difference compensator 154 may round up the compensated second broad-band pixel value. For example, the compensated ninth pixel value of 158.8, may be round up to thereby obtain an integer value of 159.

The fourth calculator 155 may calculate a restored narrow-band pixel value based on the second narrow-band pixel value, the compensated second broad-band pixel value and the color correction gain provided by the color correction gain generator 140.

For example, the fourth calculator 155 may calculate restored narrow-band pixel values R, G, and B using narrow-band pixel values R′, G′, and B′, a compensated broad-band pixel value WNIR′, and color correction gains a11, . . . , a34, as indicated by Equation (1):

$$[ \begin{matrix}R \\ G \\ B\end{matrix} ] = [ \begin{matrix}a 11 & a 12 & a 13 & a 14 \\ a 21 & a 22 & a 23 & a 24 \\ a 31 & a 32 & a 33 & a 34\end{matrix} ] [ \begin{matrix}{R}^{′} \\ {G}^{′} \\ {B}^{′} \\ {WNIR}^{′}\end{matrix} ] . \qquad ( 1 )$$

Equation (1) is merely an example of how the fourth calculator 155 may calculate a restored narrow-band pixel value. The fourth calculator 155 may compute a restored narrow-band pixel value by 1) applying a weight to, 2) adding a predetermined value to, or 3) subtracting a predetermined value from at least one of 1) the second narrow-band pixel value, 2) the compensated second broad-band pixel value, and 3) the color correction gain provided by the color correction gain generator 140. In this manner, the fourth calculator 155 may perform color correction.

The first and second images, which are used by the color correction gain generator 140 and the color corrector 150, respectively, may be identical or different from each other. For example, the color correction gain generator 140 may acquire a test image from a single-exposure environment as the first image, and may generate a color correction gain using the acquired test image, whereas the color corrector 150 may acquire an image of a target object to be captured from a dual-exposure environment as the second image, and may perform color correction using the acquired image of the target object. In this example, the first and second images may be different from each other.

As another example embodiment, the color correction gain generator 140 may acquire an image of a target object to be captured from a single-exposure environment as the first image, and the color correction gain generator 140 may generate a color correction gain using the acquired image of the target object. On the other hand, the color corrector 150 may acquire a test image from a double-exposure environment as the first image, and may perform color correction using the acquired test image. In this example embodiment, the first and second images may be substantially identical.

The color restoration apparatus 100 may improve the precision of the generation of a color correction gain by 1) compensating for broad-band pixel values based on whether the broad-band pixel values are saturated and 2) generating a color correction gain based on the compensated broad-band pixel values.

The color restoration apparatus 100 may correct color distortion and provide clear and vivid images by a) compensating for broad-band pixel values based on the difference between 1) a color gain applied to narrow-band pixel values and 2) a color gain applied to the broad-band pixel values and b) generating restored narrow-band pixel values based on the narrow-band pixel values, the compensated broad-band pixel values and a color correction gain.

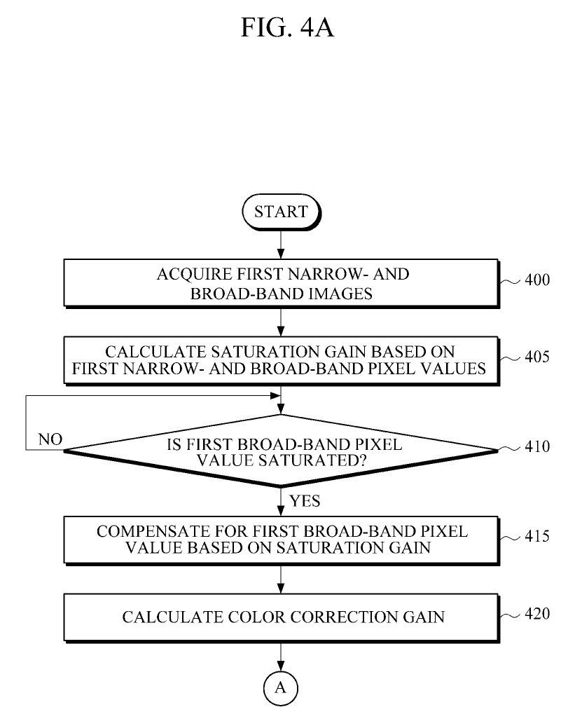

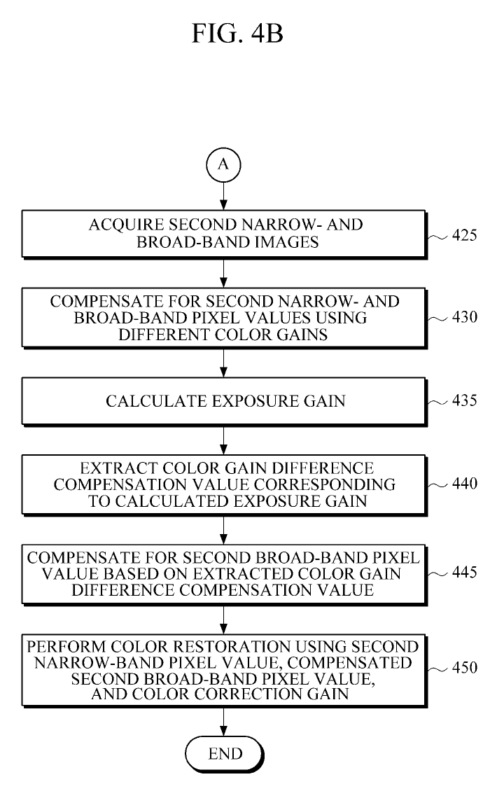

FIGS. 4A and 4B illustrate an example embodiment of a color restoration method.

Referring to FIGS. 1, 4A, and 4B, the color restoration apparatus 100 acquires a first image including first broad- and narrow-band images from a single-exposure environment (400). The first image may be a captured image for obtaining a color correction gain. The color restoration apparatus 100 calculates a saturation gain based on first narrow- and broad-band pixel values (405). For example, when there are a plurality of narrow-band color channels and thus there are a plurality of first narrow-band pixel values, the ratio of the first broad-band pixel value to the sum of the first narrow-band pixel values may be computed as the saturation gain.

The color restoration apparatus 100 determines whether the first broad-band pixel value is saturated (410). In response to the first broad-band pixel value being saturated, the color restoration apparatus 100 compensates for the first broad-band pixel value based on the computed saturation gain (415). On the other hand, when the first broad-band pixel value is not saturated, the color restoration method may return to operation 410. The color restoration apparatus 100 may calculate a color correction gain based on the first narrow-band pixel value and the compensated first broad-band pixel value (420).

The color restoration apparatus 100 may acquire a second image including second narrow- and broad-band images (425). The color restoration apparatus 100 may compensate for a second narrow-band pixel value of the second narrow-band image based on a first color gain, and compensates for a second broad-band pixel value of the second broad-band image based on a second color gain (430). The color restoration apparatus 100 may calculate an exposure gain based on the first and second color gains (435). The exposure gain may be the ratio of the first and second color gains. The color restoration apparatus 100 may extract a color gain difference compensation value corresponding to the calculated exposure gain (440). The color restoration apparatus 100 may compensate for the second broad-band pixel value based on the extracted color gain difference compensation value (445). The color restoration apparatus 100 may calculate a restored narrow-band pixel value based on the second narrow-band pixel value, the compensated second broad-band pixel value, and the color correction gain obtained in operation 420 (450).

As a non-limiting illustration, an image acquisition apparatus may be a camera, mobile phone, tablet computer, or the like.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable recording mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running. A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A color restoration apparatus comprising:
a color correction gain generator configured to compensate for a first broad-band pixel value of a first image, which is acquired from a single-exposure environment, based on a saturation gain for compensating for a difference between a time of the saturation of a broad-band pixel value and a time of the saturation of a narrow-band pixel value, and to calculate a color correction gain based on a first narrow-band pixel value of the first image and the compensated first broad-band pixel value; and
a color corrector configured to compensate for a second broad-band pixel value of a second image, which is acquired from a dual-exposure environment, based on a color gain difference compensation value for compensating for a difference between color gains applied to the second image, and to calculate a restored narrow-band pixel value based on the second narrow-band pixel value, the compensated second broad-band pixel value, and the color correction gain.

2. The color restoration apparatus of claim 1, wherein the color correction gain generator comprises a first calculator configured to calculate the saturation gain based on the first narrow-band pixel value and the first broad-band pixel value.

3. The color restoration apparatus of claim 2, wherein the first calculator is further configured to, in a case in which there are a plurality of first narrow-band pixel values, compute a ratio of the first broad-band pixel value to the sum of the first narrow-band pixel values as the saturation gain.

4. The color restoration apparatus of claim 1, wherein the color correction gain generator comprises a saturation compensator configured to compensate for the first broad-band pixel value based on the saturation gain.

5. The color restoration apparatus of claim 4, wherein the saturation compensator is further configured to compensate for the first broad-band pixel value based on the saturation gain in response to the first broad-band pixel value being saturated.

6. The color restoration apparatus of claim 1, wherein the color correction gain generator comprises a second calculator configured to calculate the color correction gain based on the first narrow-band pixel value and the compensated first broad-band pixel value.

7. The color restoration apparatus of claim 1, wherein the color corrector comprises an exposure compensator configured to compensate for the second narrow-band pixel value based on a first color gain and compensate for the second broad-band pixel value based on a second color gain to compensate for exposure.

8. The color restoration apparatus of claim 7, wherein the color corrector further comprises a third calculator configured to calculate an exposure gain based on the first and second color gains.

9. The color restoration apparatus of claim 8, wherein the third calculator is further configured to compute a ratio of the first and second color gains as the exposure gain.

10. The color restoration apparatus of claim 8, wherein the color corrector further comprises an extractor configured to extract a color gain difference compensation value corresponding to the exposure gain.

11. The color restoration apparatus of claim 1, wherein the color corrector comprises a color gain difference compensator configured to compensate for the second broad-band pixel value based on the color gain difference compensation value.

12. The color restoration apparatus of claim 1, wherein the color corrector comprises a fourth calculator configured to calculate the restored narrow-band pixel value based on the second narrow-band pixel value, the compensated second broad-band pixel value, and the color correction gain.

13. A color restoration method comprising:
compensating for a first broad-band pixel value of a first image, which is acquired from a single-exposure environment, based on a saturation gain for compensating for a difference between a time of the saturation of a broad-band pixel value and a time of the saturation of a narrow-band pixel value;
calculating a color correction gain based on a first narrow-band pixel value of the first image and the compensated first broad-band pixel value;
compensating for a second broad-band pixel value of a second image, which is acquired from a dual-exposure environment, based on a color gain difference compensation value for compensating for a difference between color gains applied to the second image; and
calculating a restored narrow-band pixel value based on the second narrow-band pixel value, the compensated second broad-band pixel value, and the color correction gain.

14. The color restoration method of claim 13, further comprising calculating the saturation gain based on the first narrow-band pixel value and the first broad-band pixel value.

15. The color restoration method of claim 14, wherein the calculating the saturation gain comprises, in a case in which there are a plurality of first narrow-band pixel values, computing a ratio of the first broad-band pixel value to the sum of the first narrow-band pixel values as the saturation gain.

16. The color restoration method of claim 13, wherein the compensating for the first broad-band pixel value comprises compensating for the first broad-band pixel value based on the saturation gain in response to the first broad-band pixel value being saturated.

17. The color restoration method of claim 13, further comprising compensating for the second narrow-band pixel value based on a first color gain and compensating for the second broad-band pixel value based on a second color gain to compensate for exposure.

18. The color restoration method of claim 17, further comprising calculating an exposure gain based on the first and second color gains.

19. The color restoration method of claim 18, wherein the calculating the exposure gain comprises computing a ratio of the first and second color gains as the exposure gain.

20. The color restoration method of claim 18, further comprising extracting a color gain difference compensation value corresponding to the exposure gain.

21. The color restoration apparatus of claim 1, wherein the first and second images are substantially the same.

22. The color restoration method of claim 13, wherein the first and second images are substantially the same.

23. A color restoration method comprising:
acquiring a first image from a single-exposure environment;
calculating a saturation gain based on a first narrow and broad-band pixel values of the first image;
in response the first broad-band pixel value being saturated, compensating the first broad-band pixel value based on the calculated saturation gain;
calculating a color correction gain based on the first narrow-band pixel value and the compensated first broad-band pixel value;
acquiring a second image from a dual-exposure environment;
compensating for a second narrow-band pixel values of the second image and a second broad-band pixel values of the second image based on a first and second color gains, respectively;
calculating an exposure gain based on the first and second color gains;
compensating the second broad-band pixel values based on the calculating exposure gain; and
calculating a restored narrow-band pixel value based on the second narrow-band pixel value, the second broad-band pixel value and the color correction gain.

24. The color restoration method of claim 23, wherein the compensating of the second broad-band pixel values comprises extracting a color gain difference compensation value corresponding to the calculated exposure gain to be used in the compensating.

25. The color restoration method of claim 23, wherein the first and second images are substantially the same.

26. An image acquisition apparatus comprising:
a housing; and
is a color restoration apparatus, the color restoration apparatus comprising:
a color correction gain generator configured to compensate for a first broad-band pixel value of a first image, which is acquired from a single-exposure environment, based on a saturation gain for compensating for a difference between a time of the saturation of a broad-band pixel value and a time of the saturation of a narrow-band pixel value, and to calculate a color correction gain based on a first narrow-band pixel value of the first image and the compensated first broad-band pixel value; and
a color corrector configured to compensate for a second broad-band pixel value of a second image, which is acquired from a dual-exposure environment, based on a color gain difference compensation value for compensating for a difference between color gains applied to the second image, and to calculate a restored narrow-band pixel value based on the second narrow-band pixel value, the compensated second broad-band pixel value, and the color correction gain.
